(19) United States
(12) Patent Application Publication
(10) Pub. No.: US 2007/0239816 A1
(43) Pub. Date: Oct. 11, 2007

(54) Formation Process for Logical and Control Functions in Information Processing and Control Systems

(76) Inventors: Valerity Ivanovich Gordienko, Kiev (UA); Sergey Egorovych Dubrovskiy, Kiev (RU); Dmitriy Vasilevych Fenev, Kiev (UA)

Correspondence Address: I. Zborovsky, 6 Schoolhouse Way, Dix Hills, NY, 11746, US

(21) Appl. No.: 11/628,646

(22) PCT Filed: Jun. 3, 2005
(86) PCT No.: PCT/UA05/00022

§ 371 Date: Dec. 6, 2006

(51) Int. Cl. G06F 7/38

(52) U.S. Cl. 708/490

(57) ABSTRACT

The invention concerns generally radio electronics in particular it relates to computer facilities and can be used in information processing and control systems. The process includes an operation of input of two data to be compared; the first operation of addition of instantaneous values of input data quantities; the first operation of mutual subtraction of the input data quantities; the operation to extract absolute modulus for instantaneous value of the result of addition; the operation to extract absolute modulus for instantaneous value of the result of mutual subtraction of input data quantities; the second operation of addition; the operation to extract absolute modulus for instantaneous value of the result of addition and the operation of subtraction of the absolute modulus for instantaneous value of the result of mutual subtraction of the input data quantities, correspondingly; the second operation of subtraction; the first final operation of the process, being an operation for an output of the results of the second operation of addition; as well as the second final operation of the process, being an operation for an output of the result of the second operation of subtraction; wherein, according to the invention, there is complemented the third final operation of the process, the above said third operation's input is the output of the operation for extracting absolute modulus for instantaneous value of the result of mutual subtraction of the input data quantities; and the fourth final operation of the process, the above said fourth operation's input is the output of the operation for extracting absolute modulus for instantaneous value of the result of addition of the input data quantities. The new essential features of the offered process which distinguish it from the prototype are the two entered final output operations providing for extension of functional possibilities of processing information, allowing realisation of the functionally completed set of logical operations, including operations of complementation.

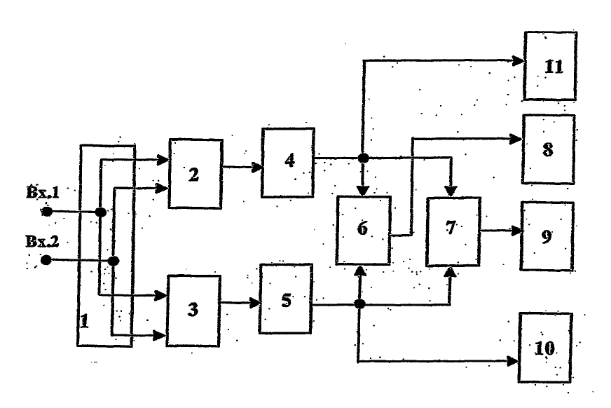

### FIELD OF THE INVENTION

The invention concerns generally radio electronics in particular it relates to computer facilities and can be used in information processing and control systems.

### ART OF THE INVENTION

There are known the processes on the basis of which the <<NAND>>, <<NOR>> operations are formed. These operations are realised at separate diode-transistor and transistor-transistor elements [1, 2].

Lacks of such processes are:

1 Narrow specialisation: only two of three base operations of binary logic can be simultaneously executed. It is impossible to form simultaneously three-and-multivalued operations within the limits of three- and- multivalued logic, continuously-valued, and “unclear’ logic [3].

2 The indicated analogues of the process do not allow simultaneously to execute at the same element logical functions and functions for electric and electronic processes control, such, for example, as modulation, phase manipulation, demodulation, sampling, peak symmetric limitation and so on. To realise these functions, different structures of functional units are usually to be used [3].

Several well-known approaches can be used to realise the indicated functions of process control [4]. However these approaches do not allow simultaneously to execute all complex of base logical operations within the limits of multivalued, continuously-valued, “unclear”, and binary logic.

The nearest to the proposed process is a formation process for logic and control functions in information processing and control systems which is realised at the universal multifunction element of the information processing systems including an operation of input of two data (x, y) to be compared and representing the operation of division of each input data quantity; the first operation of addition of instantaneous values of input data quantities which inputs being the first and second outputs of the operation for data input; the first operation of mutual subtraction of the input data quantities which inputs being the first and second outputs of the operation for data input; the operation to extract absolute modulus for instantaneous value of the result of addition of input data quantities, which input being the output of the first operation of addition of input data quantities; the operation to extract absolute modulus for instantaneous value of the result of mutual subtraction of input data quantities which input being the output of the first operation of mutual subtraction of the input data quantities; the second operation of addition which inputs being the outputs of the operation to extract absolute moduli for instantaneous values of the result of addition of the input data quantities, and the operation of subtraction of the absolute moduli for instantaneous values of the result of mutual subtraction of the input data quantities, correspondingly; the second operation of subtraction where the minuend being the output of the operation to extract absolute modulus for instantaneous value of the result of addition of the input data quantities, and subtrahend being the output of the operation to extract absolute modulus of instantaneous value of the result of mutual subtraction of the input data quantities; the first final operation of the process, being an operation for an output of the results of the second operation of addition; as well as the second final operation of the process, being an operation for an output of the result of the second operation of subtraction [5].

This process provides no possibility to realise functionally completed set of the basic logical operations because of the lack of the operation of complementation at their outputs.

### SUMMARY OF THE INVENTION

The object of the invention is to solve the technical problem of extension of functional possibilities of the known processes by introduction of additional operations, allowing to realise the functionally completed set of logical operations, including an operation of complementation. The problem is achieved by entering new final output operations.

The operations designed to extract absolute moduli of sums of data quantities to be compared expressed as |x+y| and their subtraction expressed as |x−y|, where x [symbol] y are the data quantities to be compared, are considered the internal operations of the process. Formally they are named as complementation and for a lot of problems they can carry information on mutual additionability or “distances>> between the compared data quantities. In logical problems, these operations form the indices such as “likeness degrees” and “degrees of opposition>> for compared data quantities. On completing a process, these operations (the first and second final operations) have no important informative loading.

To remove this shortage as well as extend functional possibilities of the process, the process was added with the third final operation, the above said third operation's input is the output of the operation for extracting absolute modulus for instantaneous value of the result of mutual subtraction of the input data quantities, and with the fourth final operation, the above said fourth operation's input is the output of the operation to extract absolute modulus for instantaneous value of the result of addition of the input data quantities.

Thus, for the decision of the problem, it is proposed a formation process for logical and control functions in information processing and control systems including an operation of input of two data to be compared and representing the operation of division of each input data quantity; the first operation of addition of instantaneous values of input data quantities, which inputs being the first and second outputs of the operation for data input; the first operation of mutual subtraction of the input data quantities, which inputs being the first and second outputs of the operation for data input; the operation to extract absolute modulus for instantaneous value of the result of addition of input data quantities which input being the output of the first operation of addition of input data quantities; the operation to extract absolute modulus for instantaneous value of the result of mutual subtraction of input data quantities which input being the output of the first operation of mutual subtraction of the input data quantities; the second operation of addition, which inputs being the outputs of the operation to extract absolute modulus for instantaneous value of the result of addition of the input data quantities, and the operation for subtraction of absolute modulus for instantaneous value of the result of mutual subtraction of the input data quantities, correspondingly; the second operation of subtraction where the minuend being the output of the operation to extract absolute modulus for instantaneous value of the results of addition of the input data quantities, and subtrahend being the output of the operation to extract absolute modulus of instantaneous value of the results of mutual subtraction of the input data quantities; the first final operation of the process, being an operation for an output of the results of the second operation of addition; the second final operation of the process, being an operation for an output of the result of the second operation of subtraction; the third final operation of the process, the above said third operation's input is the output of the operation for extracting absolute modulus for instantaneous value of the result of mutual subtraction of the input data quantities; and the fourth final operation, the above said fourth operation's input is the output of the operation to extract absolute modulus for instantaneous value of the result of addition of the input data quantities.

### SHORT DESCRIPTION OF DRAWINGS

The process is explained by the drawing, where a flow diagram of the offered process, included operations, and communications between them are represented.

### EMBODIMENTS OF THE INVENTION

Operation 1 is an operation of input for two data to be compared and representing the operation of division of the rate of each input data quantity (x, y) in a specified ratio, for example 1:2. The value parameters of physical processes to be compared such as electric potentials, currents, charges etc should be understood as the input data quantities. This operation will be realised by simple separation (division) of the input data quantities with the help of conductors (unit 1).

Operation 2 is the first operation of addition of instantaneous values of input data quantities (x, y,) inputs of which are the first and second outputs of operation 1 for data input. This operation is characterised by the mathematical expression:
0.5 (x+y);
and realised by standard summators or operational amplifiers (unit 2).

Operation 3 is the first operation of mutual subtraction of instantaneous values of input data quantities (x, y,) inputs of which are the first and second outputs of operation 1 for data input. This operation is characterised by the mathematical expression:
0.5 (x−y) or 0.5 (y−x);
the order of following for minuend and subtrahend does not thus matter. Operation 3 is realised by standard summators such as transistor circuit with a single inversion input or by operational amplifiers (unit 3).

Operation 4 is an operation to extract absolute modulus for instantaneous value of the result of addition of input data quantities (x, y), which input is the output for the first operation 2 of addition. This operation is characterised by the mathematical expression:
0.5 |x+y|.
In the simple case this operation will be realised at diode bridges (fullwave and inertialess rectification) or at operational amplifiers provided with diodes in feed-back circuits (unit 4).

Operation 5 is an operation to extract absolute modulus for instantaneous value of the result of mutual subtraction of input data quantities (x, y), which input is the output for the first operation 3 of mutual subtraction of the input data quantities x, y. This operation is also realised at diode bridges or operational amplifiers provided with diodes in the feed-back circuits (unit 5). The operation is characterised by the mathematical expression:
0.5 |x−y| or its equivalent 0.5 |y−x|.

Operation 6 is the second operation of addition where the addends are the output of operation 4 to extract absolute modulus for value of the results of addition of input data quantities x, y and the output of operation 5 to extract absolute modulus for instantaneous value of the result of subtraction of input data quantities x, y. The operation is characterised by the mathematical expression:
0.5 {|x+y|+|x−y|}

The operation is realised at the elements which are necessary for realisation of operation 2 and 3 that is at summators or operational amplifiers (unit 6).

Operation 7 is the second operation of the ordered subtraction where the minuend is the output of operation 4 to extract absolute modulus for instantaneous value of the result of addition of the input data quantities x, y, and subtrahend is the output of operation 5 to extract absolute modulus of instantaneous value of the result of mutual subtraction of the input data quantities x, y. The operation is characterised by the mathematical expression:
0.5 {|x+y|−|x−y|}.
The operation is realised at summators or operational amplifiers (unit 7).

Operation 8 (unit 8) is the first final operation of the process, being an operation for an output of the results of operation 6 (“collating” operation of data quantities to be compared, processes, and sets). The operation is characterised by the mathematical expression:
x∪y=0.5{|x+y|+|x−y|}. (1)
where “∪” is the representation of the operation of “collating”
Expression (1) has its analogue logic equivalent expression
x∪y=max{|x|,|y|}. (2),
Expression (2) characterises the operation being executed to select maximum from two data quantities.

Operation 9 (unit 9) is the second final operation of the process, being an operation for an output of the results of operation 7. The operation is characterised by the mathematical expression:
x∩y=0.5{|x+y|−|x−y|}. (3),
where “∩” is the representation of the operation of “intersection”.
Expression (3) has its analogue logic equivalent expression:
x∩y=sign x·sign y·min{|x|,|y|}. (4)
If values of x and y have identical signs, expression (4) is simplified and accepts the form:
x∩y=min{|x|,|y|}. (5)
Expression (5) is matched with the operation of “intersection” and interpreted as an operation for selection of less value by the absolute modulus.

Operation 10 (unit 10) is the third final operation of the process which input is the output of operation 5 to extract absolute modulus for instantaneous value of the result of mutual subtraction of the input data quantities x, y.

Operation 11 (unit 11) is the fourth final operation of the process which input is the output of operation 4 to extract absolute modulus for instantaneous value of the result of addition of the input data quantities x, y.

Operations 10 and 11 (according to the third and fourth final operations of the process) can be realised at emitting iterators. The results of operations 5 and 4 are directed to the inputs of proper emitting iterators and at their outputs there are provided the third and fourth final operations of the process.

The new essential features of the offered process which distinguish it from the prototype are the two additional final output operations, these are operations 10 and 11. These features exactly provide for extension of functional possibilities of processing information, allowing realisation of the functionally completed set of logical operations, including operations of complementation.

Taking into account expressions (2) and (3), it is possible to prove action (1) to be an equivalent of operation |x−y| (operation 5), that allows to provide for an additional output for result of operation 5 as the third final operation of the process, namely, operation 10.

Complementation which is interpreted as a <<distance>> or <<convergence degree>> between the data quantities x, y to be compared and their oppositions x, −y or −x, y, are occurred as a result of operation 4, that is why the operation providing for the output of the result of operation 4 is considered the fourth final operation of the offered process, namely operation 11.

### INDUSTRIAL PRACTICABILITY

The offered process has industrial practicability in the following areas:

1 Functional logic: binary, multivalued, continuously-valued, unclear, situational (data processing area).

2 Process control (by electric vibrations).

3 Design of network computational structures and their subsystems: synapse, neurone, managing of memory etc.

4 Correlation and filtering analysis, pattern exposure and recognition (processing productivity rise).

5 Spectral analysis (productivity benefit).

6 Providing close calculations. Managing actions over unclear objects.

7 Development of technologies for molecular-and nano-levels, neuro- and biocomputing.

8 Bionics.

### REFERENCE

[1]. [symbol] Γ. H. [symbol] [symbol] [symbol] BM-M.: [symbol] , 1978, -176 c.

[2]. [symbol] B. C. [symbol] [symbol] B [symbol] [symbol] .- [symbol] : [symbol] , 1980. -186 c.

[3]. Zadeh L. A., Fu K. S., Tanaka K., Shimura M. (1975) Fuzzy sets and their applications to cognitive and decision process, Acadamic Press (Proceedings of US-Japan Seminar).

[4]. [symbol] [symbol] C. [symbol] [symbol] [symbol] [symbol] . [symbol] [symbol] ..2-e [symbol] . [symbol] [symbol] .. M.: [symbol] , 1971 .

[5]. [symbol] , [symbol] , [symbol] , [symbol] . [symbol] [symbol] [symbol] [symbol] [symbol] [symbol] . [symbol] , 1998, [symbol] 3-c. 12-20.

1. Formation process for logical and control functions in information processing and control systems including the operation of input of two data to be compared and representing the operation of division of each input data quantity; the first operation of addition of instantaneous values of input data quantities realised at summator or operational amplifier, which inputs being the first and second outputs of the operation for data input; the first operation of mutual subtraction of the input data quantities executed at summator or operating amplifier, which inputs being the first and second outputs of the operation for data input; the operation to extract absolute modulus for instantaneous value of the result of addition of input data quantities, this operation being realised at diode bridge or operational amplifier provided with diodes in the feed-back circuit, which input being the output of the summator or the output of operational amplifier for the first operation of addition of the input data quantities; the operation to extract absolute modulus for instantaneous value of the result of mutual subtraction of input data quantities, this operation being realised at diode bridge or operational amplifier provided with diodes in the feed-back circuit, which input being the output of the summator or the output of operational amplifier for the first operation of mutual subtraction of the input data quantities; the second operation of addition realised by summator or operational amplifier which inputs being the outputs of the diode bridge or operational amplifier provided with diodes in the feed-back circuit where there is executed the operation to extract absolute moduli for instantaneous values of the result of addition of the input data quantities, and the diode bridge or operational amplifier provided with diodes in the feed-back circuit where there is executed the operation to extract absolute modulus for instantaneous value of the result of mutual subtraction of the input data quantities, correspondingly; the second operation of subtraction with the minuend being the output of the operation to extract absolute modulus for instantaneous value of the result of addition of the input data quantities, this operation being executed at the diode bridge or operational amplifier provided with diodes in the feed-back circuit, and with subtrahend being the output of the operation to extract absolute modulus of instantaneous value of the result of mutual subtraction of the input data quantities, this operation being executed at the diode bridge or operational amplifier provided with diodes in the feed-back circuit; the first final operation of the process, being an operation for an output of the results of the second operation of addition; as well as the second final operation of the process, being an operation for an output of the result of the second operation of subtraction wherein the third final operation of the process is additionally complemented, the above said third operation's input is the output for the diode bridge or operational amplifier provided with diodes in the feed-back circuit where there is realised the operation to extract absolute modulus for instantaneous value of the result of mutual subtraction of the input data quantities; and the fourth final operation of the process is additionally complemented, the above said fourth operation's input is the output for the diode bridge or operational amplifier provided with diodes in the feed-back circuit where there is realised the operation to extract absolute modulus for instantaneous value of the result of addition of the input data quantities.
